(19) United States
(12) Patent Application Publication
(10) Pub. No.: US 2015/0308971 A1
(43) Pub. Date: Oct. 29, 2015

(54) MICROFLUIDIC IMPEDANCE FLOW CYTOMETER

(71) Applicants: Christer BISGAARD, Hilleroed (DK); Thomas LAURELL, Lund (SE); Carl GRENVALL, Lund (SE); Christian ANTFOLK, Lund (SE)

(72) Inventors: Christer BISGAARD, Hilleroed (DK); Thomas LAURELL, Lund (SE); Carl GRENVALL, Lund (SE); Christian ANTFOLK, Lund (SE)

(73) Assignee: Foss Analytical A/S, Hilleroed (DK)

(21) Appl. No.: 14/395,686

(22) PCT Filed: Apr. 20, 2012
(86) PCT No.: PCT/EP2012/057290

§ 371 Date: Feb. 27, 2015

(51) Int. Cl. G01N 27/02

(52) U.S. Cl. CPC G01N 27/02

(57) ABSTRACT

A microfluidic impedance flow cytometer (‘MIC’) device (2) comprises a substrate (4) in which is formed at least one flow channel (6) for leading through a particle (22) containing fluidic sample. The flow channel (6) is formed with a focusing zone (12) and a measurement zone (14) located downstream of the focusing zone (12) in the direction of through flow and provided with an electrode arrangement (18) for characterising particles (22) in the flowing fluidic sample by means of electrical impedance wherein an acoustophoretic particle focusing arrangement (20) is provided in acoustic coupling to the flow channel (6) in the focusing zone (12) to induce acoustic forces in fluid in the flow channel (6) so as to effect a lateral and/or vertical focusing of particles before flowing to the measurement zone (14).

The present invention relates to a microfluidic impedance flow cytometer (‘MIC’).

Electrical impedance-based sensing, known as the Coulter technique, has been proposed as a candidate technique for miniaturization. A MIC device has been realised in which a cell or particle sample is suspended in a conductive solution, causing a spike in resistance between the electrodes when a low-conductivity object interrupts the electrical path, for example the successful analysis of biological cells in a microfluidic channel using impedance spectroscopy has been reported by S. Gawad et al, (“Micromachined impedance spectroscopy flow cytometer for cell analysis and particle sizing”; Lab Chip, 1, 76-82 (2001)). Nano-scale particles have been detected using this approach when the minimum channel dimensions are comparable to the particle size. However, this technique is generally only applicable to extremely well characterized and filtered sample solutions containing particles slightly smaller than the channel width. Very small channel widths lead to the problems concerning blockage of the channel whereas a wider channel width leads to varying particle positions in the channel which generates sensitivity issues.

Two-dimensional hydrodynamic focusing has previously been combined with the MIC device to conduct simple particle counting operation. See, e.g., Rodriguez-Trujillo et al, (“High-speed particle detection in a micro-Coulter counter with two-dimensional adjustable aperture”; Biosens Bioelectron, 24, 290-296 (2008)). In the Rodriguez-Trujillo device, two buffer streams on each side of the sample were used to achieve a two dimensionally focused stream with a minimum width of 2 microns. This approach puts the particle in the middle of a thin sheet of electrolyte, leaving conductive paths above and below the particle but adds a significant complication to the MIC device fabrication process in that additional channels and flow controls systems need to be constructed in order to control the buffer streams.

It has also been proposed by Sethu et al in US 2009/0051372 to provide an intricate multi-layered elastomer channel system in combination with a buffer stream in order to confine particles towards the floor of a measurement channel over which floor the measurement electrodes of the impedance spectroscopy Coulter system are disposed. Again, construction of such a complex MIC device is relatively complicated.

It is an aim of the present invention to provide a MIC device in which at least one of the aforementioned problems is mitigated.

According to a first aspect of the present invention there is provided a microfluidic impedance flow cytometer (‘MIC’) device comprising a substrate in which is formed at least one flow channel for leading through a particle containing fluidic sample, the flow channel comprising a focusing zone and a measurement zone downstream of the focusing zone in the direction of fluid flow through the flow channel and being provided with an electrode arrangement for characterising particles in the flowing fluidic sample by means of electrical impedance characterised in that an acoustophoretic particle focusing arrangement is provided in acoustic coupling to the flow channel in the focusing zone. By using acoustophoresis, a technique based on standing wave ultrasound forces, particles in the fluid flowing in the focusing zone may be aligned vertically and/or laterally before entering the measurement zone, leading to better performance since the focussed particles will be flowing in the same electric field density. Moreover, employing acoustophoresis allows for a less complicated chip fabrication and can be used for on-chip sample preparation in addition to the focusing of the target particles.

Usefully, the acoustophoretic particle focusing arrangement comprises one or more ultrasound generators acoustically coupled to a suitably dimensioned portion of the flow channel of the focusing zone to provide a (half) standing ultrasound wave in an associated lateral and/or vertical dimension. Preferably the arrangement operates to generate simultaneously both lateral and vertical focusing which has an advantage that particles in the fluid flowing in the flow channel will be subject to acoustic forces tending to provide a flowing sample downstream of the focusing zone, in the measurement zone, in which the particles are biased towards and concentrated in the centre portion of the sample fluid.

In an embodiment the electrode arrangement may consist of a plurality of planar electrodes, typically patterned across a narrowed cross-section of the flow channel. Planar electrode configurations are relatively easy to fabricate but sensitive to varying particle positions. Advantageously acoustophoretic particle focusing in the MIC device according to the present invention permits a simpler electrode fabrication to be employed where all the electrodes of the electrode arrangement are fabricated at one side of the flow channel.

According to a second aspect of the present invention there is provided a method for performing flow cytometry in a microfluidic impedance flow cytometer having a flow channel formed in a substrate, comprising the steps of: focusing particles within a flowing fluidic sample stream in one or both a lateral or a vertical direction with respect to the direction of flow by applying ultrasound acoustic energy to the sample stream within a suitably dimensioned portion of a flow channel of the microfluidic device; detecting, at a measurement zone of the flow channel electrical, impedance changes using an electrode arrangement located at that zone; and analyzing in an analyzer connected to the electrode arrangement the detected impedance changes to provide one or both quantitative and qualitative information on particles within the flowing fluidic sample.

In order to illustrate these and additional advantages of the present invention an exemplary embodiment of a MIC device according to the present invention will be described in greater detail below with reference to the drawings of the accompanying figures, of which:

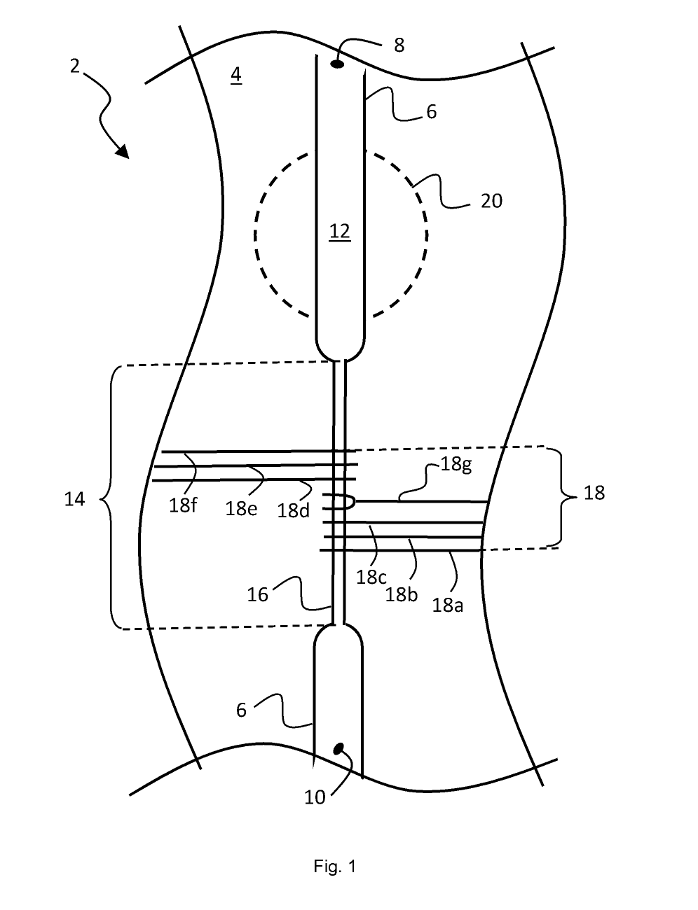

FIG. 1 illustrates a plan view of a portion of a MIC device according to the present invention;

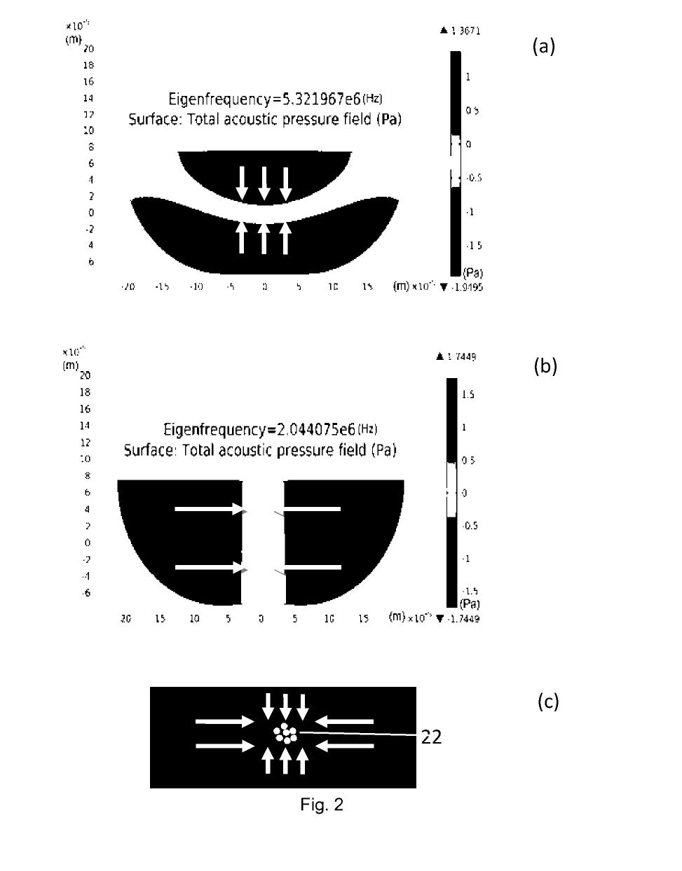

FIG. 2 illustrate theoretical simulations of acoustic forces present in a flow channel of a particular realization of a MIC device according to FIG. 1; and

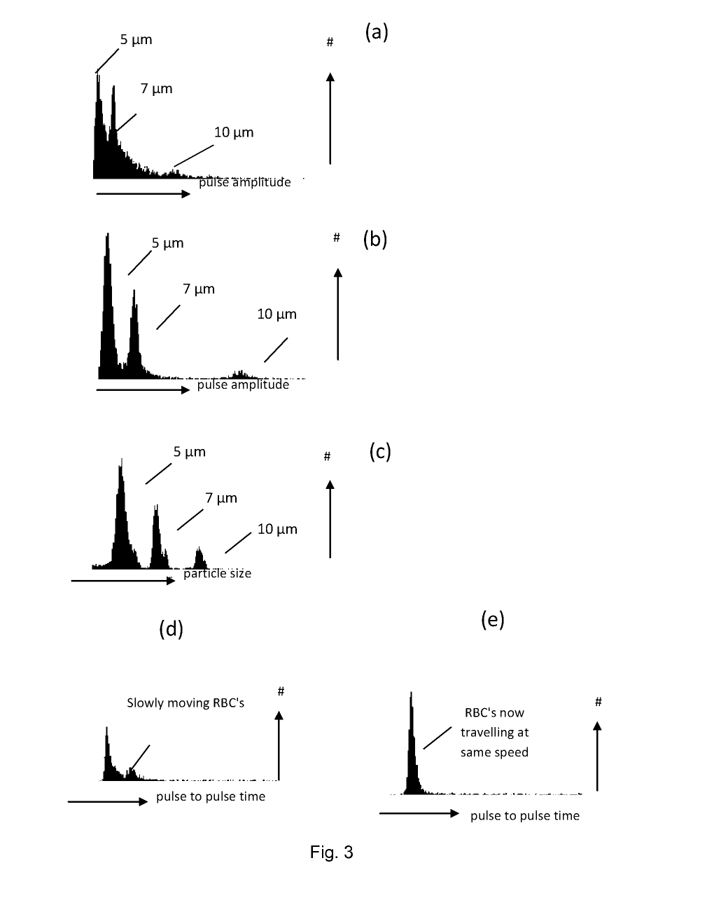

FIG. 3 illustrate experimental results from the particular realization simulated in FIG. 2.

With reference to FIG. 1 a portion of a microfluidic impedance flow cytometer (MIC) device 2 is illustrated (not to scale) and comprises a substrate 4 (or carrier), in this example suitably provided by a planar glass sheet, in which is provided, here by a two-step wet etching technique, an elongate sample flow channel 6, having an inlet 8 connectable to a suitable device for feeding a fluid, typically a liquid but possibly a gas and an outlet 10. The channel 6 is provided with a focusing zone 12 and, downstream of this in the direct ion flow of a particle containing sample fluid, a measurement zone 14 with different cross sectional dimensions. In particular the flow channel portion 16 of measurement zone 14 being substantially narrower and shallower than that of the focusing zone 12.

In the measurement zone 14 an electrode arrangement 18 is formed, here as planar electrodes patterned across the narrower flow channel 16 of the measurement zone 14 in order to allow impedance spectroscopy measurements to be performed. By way of example only, the electrode arrangement is shown to consist of six measurement electrodes 18a . . . f and one forked electrode 18g to act as a signal output to an analyser (not shown) and are each terminated with an externally accessible electrical contact or pad (not shown).

An acoustophoretic particle focusing arrangement 20, here comprising an ultrasound generator located beneath the substrate 4 directly below the focusing zone 12 of the flow channel 6, is provided in acoustic coupling to the focusing zone 12 in order to generate acoustic forces within fluid in that zone 12 through the creation of a (half) standing wave in one or both the lateral and vertical directions.

In a particular realization of the exemplary embodiment of the present invention as illustrated in FIG. 1 which has been employed to generate experimental data discussed later the ultrasound generator of the particular acoustophoretic particle focusing arrangement 20 is adapted to generate standing wave ultrasound at 5 (vertically) and 2 (laterally) MHz respectively. The electrodes 18a . . . g of this particular realization are platinum electrodes with a thickness of 200 nm, a width of 20 μm and a space of 30 μm between adjacent electrodes. These, unconventionally, are patterned across one side (here illustrated as across the bottom) of the narrow flow channel portion 16 of the measurement zone which is 35 μm wide, 80 μm deep and extends 1500 μm in order to allow impedance spectroscopy measurements. Normally this is not a very good configuration since there will exist an inhomogeneous electrical field in the channel 16 and the impedance readout hence becomes dependent of the particle position in the channel 16 of the measurement zone 12. With the acoustophoretic focusing this does however no longer affect the impedance readout as the particles enter the measurement zone 12 substantially in the same spatial location.

Computer simulations using known physical modelling software, here Comsol™ modelling software available from ComSol AB, Sweden, were performed in order to optimize for standing wave ultrasound at these frequencies resulted in a 420 μm wide and 150 μm deep flow channel 6, at least in the focusing zone 12 but usefully also in the region of the channel 6 downstream of the measurement zone 14, which region connects with the outlet 10. The results of these simulations for the 150×420 μm focusing channel 12 are illustrated in FIG. 2 with acoustic force direction indicated by arrows. Vertical focusing dimensions was simulated for a ˜5.3 MHz half standing wave and illustrated in FIG. 2(a). Lateral focusing dimensions was simulated for a ˜2.0 MHz half standing wave and illustrated in FIG. 2(b). The combined effect of these forces on particles 22 in a flowing fluid stream in the flow channel 6 after focussing in the focusing zone 12 is shown in FIG. 2(c) which when active simultaneously, these acoustic forces should, according to theory (and as discovered in practice), cause particles 22 to focus into the centre portion of the laminar flow.

In order to evaluate the particular realization of the MIC device described above two different particle suspensions were used. 5, 7 and 10 μm polystyrene beads were suspended in 0.9% NaCl MQ water. Blood was diluted 500 times in PBS. Flow was set to 5 μl/min. Differential impedance spectroscopy was performed at 3 MHz and 800 mV output. Acoustic forces were induced using piezoelectric transducers of the acoustophoretic focusing arrangement 20 attached to the bottom of the substrate 4 beneath the focusing zone 12 portion of the flow channel 16. The transducers 20 were actuated by signal generators. The raw data was analysed in an associated analyzer (not shown) using the “findpeaks” function in Matlab and electric pulse amplitudes extracted together with differential (+) pulse to (−) pulse time values for each particle which can be used to evaluate flow speed between the two measuring electrode areas in the MIC device. The polystyrene bead mix data from the MIC device was compared with data using a conventional coulter counter, here the Multisizer™ 3 Coulter counter from Beckman Coulter Inc., in order to further evaluate MIC device performance.

The results are illustrated in FIG. 3 (where ‘#’ denotes ‘count number’) for the mix of 5, 7 and 10 μm polystyrene beads suspended in 0.9% NaCl MQ water could be detected. A peak amplitude histogram without the acoustophoretic focusing arrangement 20 activated is shown ion FIG. 3(a). However, analysis of the time between the two differential impedance pulses for each particle indicated that they were spread across the channel 16 of the measurement zone 14 (which could also be seen using visual inspection in a microscope), thus travelling at different velocities. When activating the acoustophoretic focusing arrangement 20 the pulse amplitude distribution is better and as can be seen from the histogram of FIG. 3 (b) the different size beads are easier to distinguish, with the 10 μm population now well defined. Data from the focused particle experiments correlates well to obtained data from the Multisizer 3 Coulter counter which is illustrated in FIG. 3(c). Pulse to pulse time histograms for red blood cells (‘RBC's’) in PBS solution indicate successful acoustophoretic focusing of the RBC's (see FIG. 3(e) when compared to the results obtained with no acoustophoretic focusing where the presence of slowly moving RCB's is indicated by the presence of a smaller amplitude peak (see FIG. 3 (d)).

The present invention will facilitate the provision of an integrated device with acoustic pre-treatment of a sample, for example raw milk or blood, with particle sorting, alignment and subsequent cytometry on a single chip.

1. A microfluidic impedance flow cytometer (‘MIC’) device (2) comprising a substrate (4) in which is formed at least one flow channel (6) for leading through a particle (22) containing fluidic sample, the flow channel (6) comprising a focusing zone (12) and a measurement zone (14) located downstream of the focusing zone (12) and provided with an electrode arrangement (18) for characterising particles (22) in the flowing fluidic sample by means of electrical impedance characterised in that an acoustophoretic particle focusing arrangement (20) is provided in acoustic coupling to the flow channel (6) in the focusing zone (12).

2. A MIC device (2) as claimed in claim 1 characterised in that the acoustophoretic particle focusing arrangement comprises one or more ultrasound generators (20) acoustically coupled to a suitably dimensioned portion of the flow channel (6) of the focusing zone (12) to provide, when activated, a standing ultrasound wave in an associated one or both a lateral and a vertical dimension of the flow channel (6) of the focusing zone (12).

3. A MIC device (2) as claimed in claim 2 characterised in that the acoustophoretic particle focusing arrangement (20) is adapted to generate ultrasound to simultaneously provide a half standing ultrasound wave in both a lateral and a vertical dimension.

4. A MIC device as claimed in any preceding claim characterised in that the electrode arrangement (18) comprises a plurality of planar electrodes (18a . . . g) provided across on side of a measurement channel (16) of the measurement zone (14).

5. A method for performing flow cytometry in a microfluidic impedance flow cytometer (MIC) having a flow channel formed in a substrate, comprising the steps of: focusing particles within a flowing fluidic sample stream in one or both a lateral or a vertical direction with respect to the direction of flow by applying ultrasound acoustic energy to the sample stream within a suitably dimensioned portion of a flow channel of the microfluidic device; detecting, at a measurement zone of the flow channel electrical, impedance changes using an electrode arrangement located at that zone; and analyzing in an analyzer connected to the electrode arrangement the detected impedance changes to provide one or both quantitative and qualitative information on particles within the flowing fluidic sample.
